(19) United States
(12) Patent Application Publication
(10) Pub. No.: US 2005/0034362 A1
(43) Pub. Date: Feb. 17, 2005

(54) Landscape edging, and methods

(75) Inventors: Mark Carlton Anderson, Buffalo Lake, MN (US); Dwight David Anderson, Champlin, MN (US); Paul Newton Anderson, Buffalo Lake, MN (US)

Correspondence Address: KAGAN BINDER, PLLC, SUITE 200, MAPLE ISLAND BUILDING, 221 MAIN STREET NORTH, STILLWATER, MN, 55082, US

(73) Assignee: Hector Tile Company, Inc.

(21) Appl. No.: 10/639,822

(22) Filed: Aug. 13, 2003

(51) Int. Cl. A01G 1/08

(52) U.S. Cl. 47/33

(57) ABSTRACT

The disclosure is directed to landscape edging, such as blocks. Multiple blocks can be assembled to form a border around flower beds, trees, and other landscaping. A first end of the edging block includes a groove or mortise engageable with a second end of a second edging block having a tongue or tenon. The overlapping system inhibits growth of grass or other vegetation between two adjoining blocks. The edging includes a lip on at least one side that may function as a mowing strip or ledge. The block may be straight or curved, thus allowing multiple blocks to be assembled to form various configurations.

### FIELD OF THE INVENTION

The invention relates to concrete edging blocks for use in landscaping and other applications. A first end of the edging block includes a first portion of an engagement system engageable with a second end of a second edging block having a second portion of the engagement system. The edging block includes a lip on at least one side that may function as a mowing strip.

### BACKGROUND OF THE INVENTION

Numerous methods and materials exist for the construction of borders or edging for landscaping or site improvement work. Such borders or edges serve several functions. First, they are decorative, and provide an orderly transition from a garden area to a lawn, or from a lawn to a sidewalk, etc. Second, they serve to separate different areas with different forms of vegetation or other landscaping elements, thereby reducing maintenance requirements such as removing weeds, or trimming back vegetation that would otherwise spread. Third, they can ease the process of lawn mowing by eliminating the need to hand trim the border areas of the lawn after mowing the main areas with a mechanical lawn mower.

One method for the construction of edgings for use around gardens or to divide sections of a garden involves the use of extended lengths of flexible metal or plastic edging materials that are anchored by digging a trench, placing the edging material, anchoring the edging material by driving spikes through it into the ground, and then filling the trench with dirt. Such methods are common and relatively inexpensive, but have several disadvantages. First, these edgings do not have a natural, orderly appearance that is aesthetically pleasing in a landscaping application, having instead a man-made appearance. Also, these materials are not easily fixed in straight lines or measured curves due to their flexible nature. Many times, the plastic is difficult to straighten after having been packaged coiled or wound. Further, materials are readily susceptible to damage during lawn mowing, digging, and other activities where sharp objects may contact the material, especially the plastic material. Additionally, such edgings are susceptible to heaving from frost action in climates where the ground freezes.

One example of a three-dimensional, plastic lawn edging system is disclosed in U.S. Pat. No. 4,976,063. This system has releaseably joined straight and corner edging components that are attached together to form an extended length of edging. Such a system avoids some of the disadvantages discussed above in relation to the extended length, flexible plastic edging. However, the edging system disclosed in U.S. Pat. No. 4,976,063 still has some drawbacks, for example, the system does not allow for measured curves or allow for adjustments in the alignment between individual components.

Another method of providing an edging is using natural stones or man-made bricks or blocks. Such stones or bricks are usually installed by digging a shallow trench and placing the stones or bricks more or less continuously along the length of the trench. Such materials may also simply be placed on top of the ground without digging a trench. Natural stone has long been used for this application, however natural stone typically has irregular shapes and requires labor-intensive fitting of the natural stones along the border or edging, or costly cutting of the pieces to fit. The irregularity also makes natural stone difficult to accommodate lawn mowing. Bricks or rectangular blocks may also be used for lawn edging using similar installation techniques. Rectangular blocks do not lend themselves to the construction of curvilinear edgings, which are found in most landscaping applications, because they must be cut to avoid gaps that may allow penetration of grass roots or other vegetation and to provide an orderly appearance.

Another method for forming an edging or border has been to pour a concrete edging in place. The disadvantages of this method are the expense and effort involved. To install such an edging, an adequate trench must be dug, then forms must be constructed laying out the line of the edging, then the concrete must be mixed, poured, and allowed to cure. Such edgings may also require the placement of expansion material filled joints, and are susceptible to cracking. In addition, such edgings are not readily removed in the event a change in the contour of the lawn or garden border is desired. Finally, such edgings do not provide a desirable natural appearance.

There have also been efforts to address some of these deficiencies in the prior art through masonry block designs and wet cast concrete designs that are meant specifically for use as an edging. These designs use either single units that are capable of being laid in straight or curved lines, or multiple unit systems with curved and straight pieces. These products are produced on concrete masonry block or paving machines, or through pre-casting with numerous concrete forms, and are designed to allow the construction of curved edgings. Such curbing suffers from many of the limitations discussed above regarding edging, e.g., lack of curvilinear construction without time-consuming and costly on-site cutting, and susceptibility to heaving from freeze/thaw cycles. An example of a concrete edging block is disclosed in U.S. Pat. No. 5,568,994. This block includes a passage or groove along its length in the bottom for receiving an anchoring strip or defining a conduit. The block may be straight or curved, thus allowing multiple blocks to be arranged to provide a structure similar to curbing.

Paver stones, though usually used for horizontal expanses such as patios and walkways, have also been used as landscape edging. Typically, pavers are restrained by plastic or metal strips fixed in a manner similar to the flexible edging materials discussed above. For similar reasons, pavers and their edge restraints are also difficult to fix in straight measured curves, and are susceptible to heave from freeze/thaw cycles.

What is needed is an improved landscape edging material, which is economical, easy to install, and is versatile. Also needed is a landscape edging material that is durable and which allow easy maintenance around the edging material.

### SUMMARY OF THE INVENTION

The present invention is directed to concrete block edging for use in landscaping applications. The edging block has a front face, an opposite back face, a top surface and a bottom surface that sits on the ground. During installation, typically, the front face is positioned on the side of any grass or lawn being edged by the block. The back face is positioned on the side of landscaping plants, trees, or the like.

One object of the landscape edging blocks of this invention is to provide segmented landscape edging that has overlapping joints, to inhibit growth of grass and other vegetation between the blocks and thus inhibit the growth from entering the landscape area. An overlapped joint allows for small adjustments in alignment of adjacent blocks without creating gaps between blocks.

A first end of the edging block includes a first portion of an engagement system engageable with a second end of a second edging block having a second portion of the engagement system. No external attachment means are needed to connect the blocks. The engagement system is such that a vertical line, drawn between the joined first portion and the second portion, passes through each of the first end of the first block and the second end of the second block. Such an overlapping joint inhibits vegetation, such as grass, from growing between adjacent blocks. The engagement system portions at each end are present closest to the bottom surface of the block and generally are not present at the top surface. In some embodiments, the edging block includes a mowing feature on at least the front face of the block to facilitate grass mowing and minimize edge trimming.

The overlapping joint may include a “key” element to increase resistance to lateral movement between adjacent and adjoining edging blocks. Movement of blocks can be caused by larger mowers pushing against the landscaping edging; having a key element inhibits lateral movement.

A second object of the landscape edging blocks is to provide a landscape edging that is easy to initially install and easy to later modify, if desired. The edging of the present invention is an improvement over concrete landscape edging that is poured or cast in place with a machine, which is a labor intensive process. Individual blocks of edging allow for modifications in alignment and positioning of the edging, as compared to poured edging.

Another object is to provide an edging that is economical compared to the cast or poured in place edging.

Yet another object is to provide a landscape edging that is durable and attractive. The edging of the present invention is able to withstand lawn mowing equipment, which often damages flexible plastic edging. Additionally, the edging of the present invention is not damaged or displaced by soil movement due to frost heave. Cast in place concrete edging can often crack due to frost heave.

A further object is to provide an edging that facilitates landscape maintenance. The edging of the present invention preferably includes a mowing feature that allows the mower deck of a lawn mower to ride over the edging and thus eliminate the need for trimming.

The landscaping edging blocks of the invention allow the edging to be present as curved shapes and curves that fit to and compliment the landscape areas. Previously, edging was available in only straight segments, angled segments, and combinations, which generally does not make attractive, gradual segments and curves that confirm to the landscape.

In one particular embodiment, the invention is directed to a concrete landscape edging block comprising a body having a first end, an opposite second end, a front surface, an opposite back surface, a bottom surface and a top surface. A first, recessed engagement portion is positioned at the first end and a second, extension engagement portion at the second end and extending away from the second end, the second extension engagement portion corresponding to and interconnectable with the first recessed engagement portion. A mowing feature present in the body.

In another particular embodiment, the invention is directed to a concrete landscape edging block comprising a body having a first end, an opposite second end, a front surface, an opposite back surface, a bottom surface and a top surface. A first recessed engagement portion is localized at the bottom surface at the first end; and a second extension engagement portion localized at the bottom surface at the second end. The second engagement portion is corresponding to and interconnectable with the first engagement portion. Such a concrete block can include a mowing feature.

In a further particular embodiment, the invention is directed to a plurality of edging blocks connected to form an edging border. The edging border comprises a first block and a second block, each block having a body having a first end, an opposite second end, a front surface, an opposite back surface, a bottom surface and a top surface. Each block also has a first engagement portion at the first end and a second engagement portion at the second end, with the second engagement portion corresponding to and interconnectable with the first engagement portion. In use, the first engagement portion of the first block is engaged, at least partially, with the second engagement portion of the second block.

In another particular embodiment, the invention is directed to a plurality of edging blocks connected to form an edging border, the edging border comprising a first block and a second block. Each of the blocks has a body having a first end, an opposite second end, a front surface, an opposite back surface, a bottom surface and a top surface. Each of the blocks also has a first engagement portion at the first end and a second engagement portion at the second end, with the second engagement portion corresponding to and interconnectable with the first engagement portion. Together, the first engagement portion of the first block and the second engagement portion of the second block provide means for inhibiting vertical slippage between the first block and the second block. In some embodiments, the first engagement portion of the first block and the second engagement portion of the second block provide means for inhibiting lateral slippage between the first block and the second block.

In still a further embodiment of the invention, a method of making a concrete landscape edging block is provided, the block comprising a body having a first end, an opposite second end, a front surface and a bottom surface, with a first engagement portion at the bottom surface at the first end and a second engagement portion at the bottom surface at the second end, the second engagement portion corresponding to and interconnectable with the first engagement portion, and with a mowing feature present in the front surface. The method comprises steps of providing a mold constructed to provide the body of the edging block, filling the mold with a cementitious material to form a block, and removing the block from the mold.

Additional embodiments are also disclosed.

### BRIEF DESCRIPTION OF THE DRAWINGS

Referring to the Drawing where like numerals represent like parts throughout the several views:

FIG. 1 is a perspective view of a typical application for the edging of the present invention.

FIG. 2 is perspective view showing the front, side and top of an edging block of a first embodiment;

FIG. 3 is an end view of the edging block of FIG. 2;

FIG. 4 is a partial front view of the edging block of FIG. 2;

FIG. 5 is a front view of two of the edging blocks of FIG. 2 engaged;

FIG. 6A is a top view of the edging block of FIG. 2;

FIG. 6B is a top view of a variation of the edging block of FIG. 2, except having a first radius;

FIG. 6C is a top view of a variation of the edging block of FIG. 2, except having a second radius;

FIG. 6D is a top view of a variation of the edging block of FIG. 6B, except having an opposite first radius;

FIG. 6E is a top view of a variation of the edging block of FIG. 6C, except having an opposite second radius;

FIG. 7 is a perspective view showing the front, side and top of an edging block of a second embodiment;

FIG. 8 is an end view of an edging block of a third embodiment;

FIG. 9 is an end view of an edging block of a fourth embodiment;

FIG. 10 is a top view of an edging block of a fifth embodiment; and

FIG. 11 is a cross-sectional view of the edging block of FIG. 10 taken along line 11-11 of FIG. 10.

### DETAILED DESCRIPTION OF THE PREFERRED EMBODIMENT

Referring to the figures there is generally illustrated therein a preferred embodiment of a landscape edging that incorporates the principles of this invention. While the preferred embodiment of the invention will be described in association with its applicability to landscape edging, it will be understood that the broad principles of the invention are not limited to such products or to the specifics of the preferred embodiment machine disclosed. The described edging represents one clear example incorporating the principles of the claimed invention, but the invention is not intended to be construed in a limiting manner as a result of the preferred embodiment disclosure.

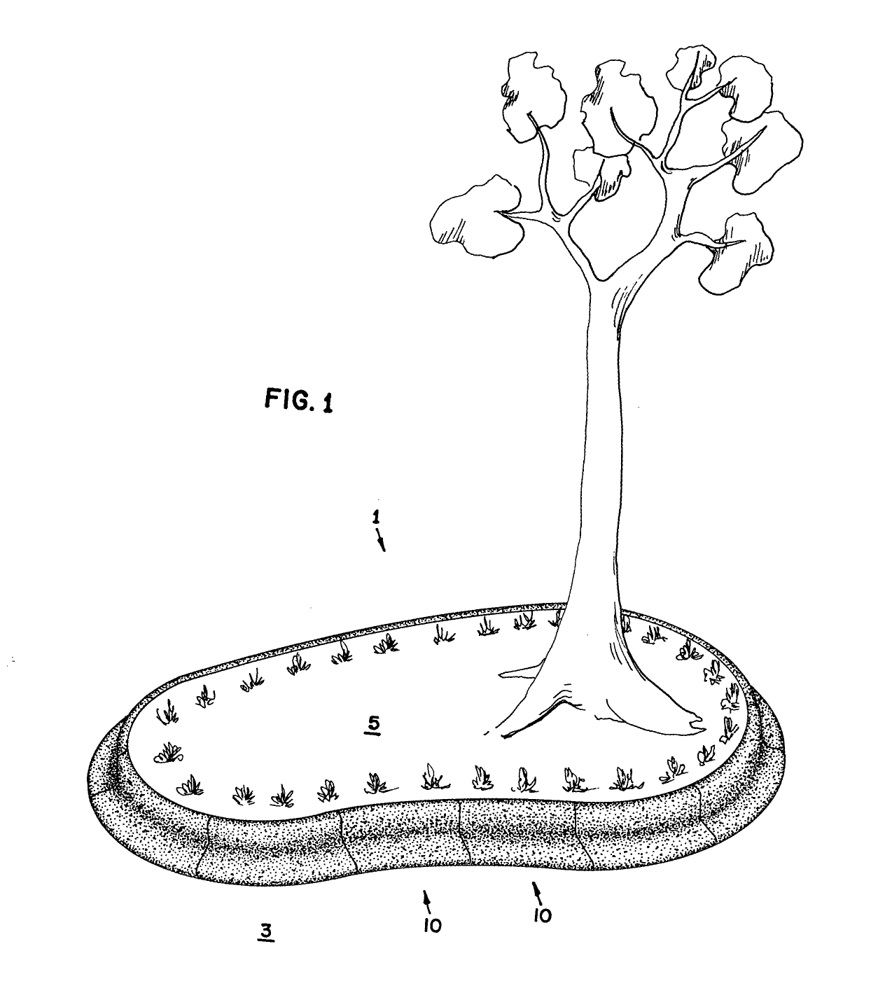

In FIG. 1 there is illustrated a typical application for landscape edging according to the present invention. Continuous edging 1, made of multiple edging blocks, such as edging block 10 according to the present invention, is installed to provide a separation or break between two areas 3, 5, one of the areas typically being grass. Often, the installation encircles or encompasses an area such as a tree or flowerbed. The edging can be a boundary or border keeping loose items such as woodchips or rocks controlled. In FIG. 1, exterior area 3 could have grass present, and interior area 5 is illustrated having a tree and other vegetation.

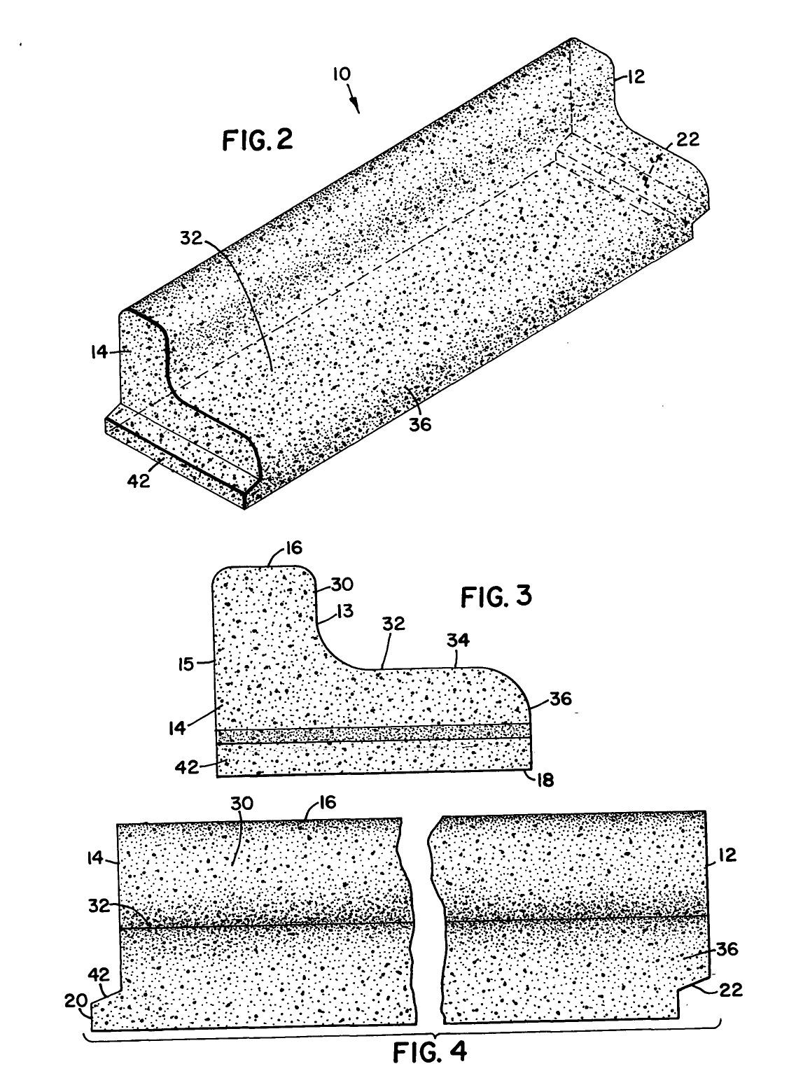

FIGS. 2 and 3 show a closer view of edging block 10, which, in combination with other edging blocks, creates the continuous edging 1 shown in FIG. 1. Edging block 10 has a general first end 12 and an opposite general second end 14. Edging block 10 further has a front side 13 (see FIG. 3) and an opposite back side 15 (see FIG. 3). In use, front side 13 is the exterior side, typically exposed to grass, such as area 3 as illustrated in FIG. 1, and back side 15 is the interior side, typically exposed to the landscaping material, such as the trees, flowers, rocks, woodchips, and the like present in area 5, FIG. 1. Edging block 10 also has a top surface 16 (FIG. 3) and a bottom surface 18 (FIG. 3), which is positioned against the ground when installed.

The length of edging block 10, from general first end 12 to general second end 14 is at least 4 inches. Typically, the length is no more than about 3 feet (36 inches) from general first end 12 to general second end 14. In many embodiments, edging block 10 is 1 foot (12 inches) to 2 feet (24 inches) long. A length of about 14 inches to about 20 inches is most suitable, and a length of about 16 to about 18 inches is preferred for an embodiment.

The maximum width, or depth, of edging block 10, from front side 13 to opposite back side 15 is at least 2 inches. Typically, the width is no more than about 12 inches. In many embodiments, edging block 10 is about 4 inches to 8 inches wide. A width of about 4 inches to 6 inches is most suitable.

The height of edging block 10, from top surface 16 to bottom surface 18 is at least 2 inches. Typically, the height is no more than about 16 inches. In many embodiments, edging block 10 is about 4 inches to 12 inches tall. A height of about 4 inches to 8 inches is most suitable.

Front side 13 includes a first portion 30 from which extends a mowing feature 32. In the embodiment illustrated in FIGS. 2 and 3, mowing feature 32 is configured for facilitating mowing along edging block 10. Particularly, mowing feature 32 is configured to allow a wheel of a lawn mower to ride thereon, thus providing a cleaner, more manicured look to the landscape. The need for subsequent trimming is also reduced. From mowing feature 32 to bottom surface 18 extends a second portion 36, which is approximately parallel to first portion 30.

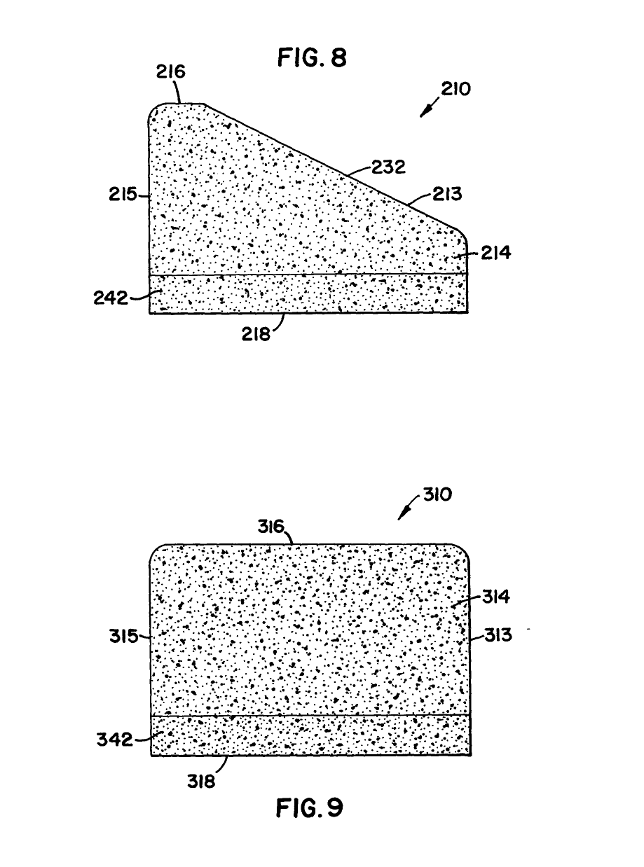

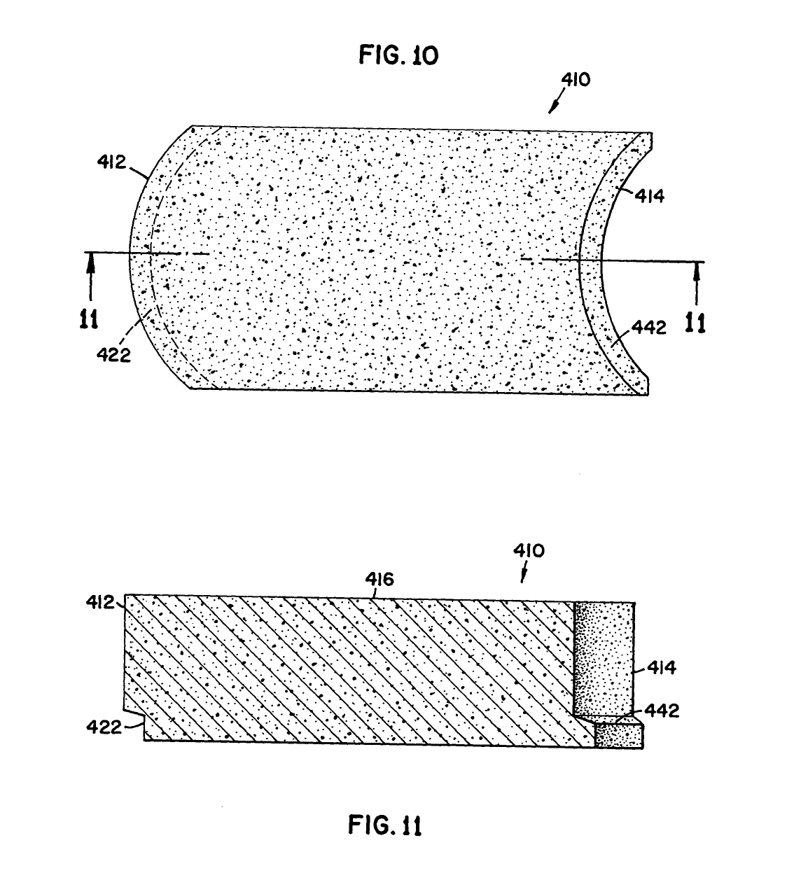

In the embodiment illustrated in FIGS. 2 and 3, mowing feature 32 includes a ledge 34 (FIG. 3) which, in this embodiment, is a generally horizontal extension. By “horizontal”, what is intended is ledge 34 is generally parallel to bottom 18 and to the ground on which edging block 10 resides. It is understood that alternate configurations of mowing feature 32 could be present on edging block 10. For example, mowing feature 32 may be sharply defined and angular (for example, having a 90 degree angle between first portion 30 and ledge 34 and/or ledge 34 and second portion 36), or mowing feature may be rounded or radiused at the transitions between first portion 30 and ledge 34 and/or ledge 34 and second portion 36, as illustrated in FIG. 3. Other configurations of mowing features are discussed below in relation to FIGS. 8 and 9.

When installed in a landscaping application, edging block 10 can be positioned so that mowing feature 32 is vertically positioned as desired; that is, the height of mowing feature 32 can be adjusted. Often, edging block 10 is merely placed and positioned on the ground. To adjust the vertical position of block 10 and mowing feature 32, for example, edging block 10 could be placed in a slight recess or ditch in the ground, thus lowering edging block 10 and mowing feature 32. A mowing feature approximately level with the ground may be preferred by some landscapers based on the ease of obtaining a more level and even lawn by having the lawn mower wheel, when positioned on the mowing feature, approximately even with the ground. The height of second portion 36 will factor in the vertical placement of mowing feature 32.

Measured between top surface 16 and mowing feature 32 (such as ledge 34), first portion 30 of front side 13 elevates top surface 16 above the general level of the grass or other material positioned on the exterior of edging block 10, that is, positioned on the side of front side 13. The height of first portion 30 is generally sufficient to provide a boundary or wall between grass at the exterior and top surface 16. Typically, the height of first portion 30, measured between top surface 16 and mowing feature 32, is about 1 inch to 6 inches. In many embodiments, the height of first portion 30 is 2 to 4 inches.

Second portion 36, measured between mowing feature 32 and bottom surface 18, elevates mowing feature 32 above the general level of the ground on which block 10 is positioned. Typically, the height of second portion 36, measured between bottom surface 18 and mowing feature 32, is about 1 inch to 6 inches. In many embodiments, the height of second portion 36 is about 2 to 4 inches.

Attention is now directed to FIG. 4 in addition to FIGS. 1 and 2. Edging block 10 has first end 12 and second end 14, which together form an overlapping engagement system. By use of the term “engagement system”, what is intended is a system that has two portions which are capable of engaging, meshing, interlocking, interjoining, or otherwise coordinating together to provide abutting relation. By use of the term “overlapping”, what is intended that, when engaged, the first portion is positioned above the second portion.

First end 12 includes a portion that accepts of portion of second end 14, thus providing an engagement between first end 12 and second end 14. No external attachment means, such as clips, stakes, or the like are needed to connect the blocks. The overlap engagement between first end 12 and second end 14 provides that a vertical line, drawn between the joined first portion and the second portion, passes through at least one of the first block and the second block. The engagement system could be described as a male/female engagement system.

As best seen in FIG. 4, but also illustrated in other figures, first end 12 includes a recessed portion 22. Recessed portion 22 is a groove, indent, concave portion, or other female-like feature extending in from first end 12 toward second end 14; recessed portion 22 does not extend past first end 12. In the embodiment illustrated in FIGS. 2 through 4, the top of recessed portion 22 extends at an angle relative to bottom surface 18, although in other embodiments recessed portion 22 could extend parallel to bottom surface 18. An angled surface, that is, not perpendicular to first end 12, is easier to mold with concrete than a surface which is perpendicular to first end 12.

Second end 14 includes an extension portion 42. Extension portion 42 is a tongue, detent, convex portion, or other male-like feature extending out past second end 14; extension portion 42 extends away from second end 14 defining an endmost portion 20. In the embodiment illustrated, the top of extension portion 42 extends at an angle relative to bottom surface 18, although in other embodiments, extension portion 42 can extend parallel to bottom surface 18.

In the preferred embodiment, recessed portion 22 and extension portion 42 do not provide a complete overlap of first end 12 with second end 14 of block 10. Rather, only the portions 22, 42 themselves overlap and connect, providing a localized connection. The faces of ends 12, 14 merely abut, or approximately abut, each other. The overlap of first end 12 with second end 14 occurs proximate to bottom surface 18 of block 10. No overlap of the ends occurs at top surface 16 of block 10. This localized overlap is preferred, because it allows more flexibility in positioning (i.e., pivoting, etc.) of adjoining blocks. By “proximate the bottom surface”, “localized at the bottom surface”, and variations thereof, what is intended is no more 50% of the total block height from the bottom surface is the overlap engagement system, preferably no more than about 35% of the total block height, and in some preferred embodiments, no more than about 25% of the total block height. In one preferred embodiment, for a 4 inch high block, “proximate the bottom surface” would be within 2 inches of the bottom surface, preferably within about 1.5 inches of the bottom surface. In a further preferred embodiment, a 4 inch high block would have an overlap engagement system that is about 1 inch. Use of the terms “proximate” and “localized” is intended to refer to the overlap engagement system being close to the bottom surface and not extending elsewhere in the block.

Although the terms groove/tongue, indent/detent, concave/convex, male/female have been used to describe the engagement, connection or overlapping system of block 10, it is understood that any configuration that allows releasable, and preferably adjustable, connection and interaction between first end 12 and second end 14 is suitable. For example, recessed portion 22 can be a mortise, and extension portion 42 can be a tenon, or, recessed portion 22 can be a lock, and extension portion 42 a key. In an alternate embodiment, each of first end 12 and second end 14 may include both a recessed portion 22 and an extension portion 42, thus providing two interlocking or engaging features for the block connection. It is preferable that the design of the engagement portions be selected to allow for sufficient strength of the portion and to allow easy removal of the concrete block from the mold during manufacturing; additional details regarding manufacturing of blocks 10 are provided below.

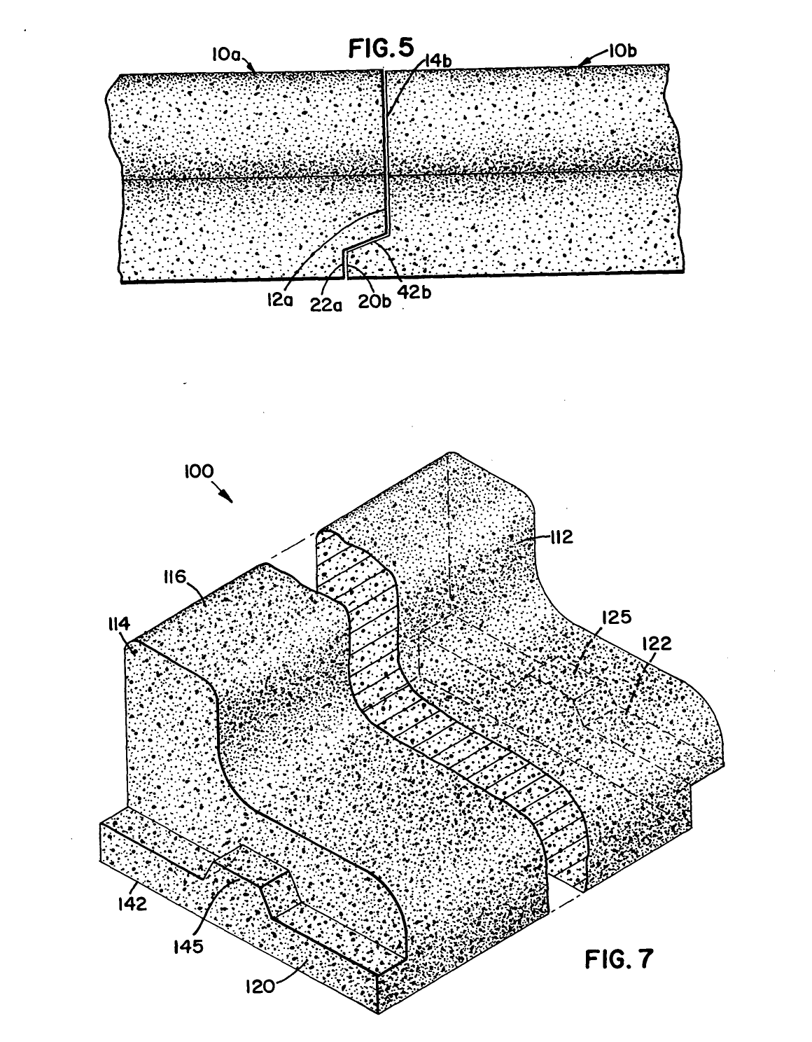

The engagement of recessed portion 22 with extension portion 42 provides a desired overlapping connection between first end 12 of a first block and second end 14 of a second block. Referring to FIG. 5, a portion of first edging block 10a is illustrated overlapped with a portion of second edging block 10b. First end 12a of first block 10a, which includes recessed portion 22a, overlaps second end 14b of second block 10b. In particular, second block 10b includes extension portion 42b, with endmost portion 20b, which fits into recessed portion 22a. Recessed portion 22a provides an overlap of block 10a over a portion of block 10b. As can be seen in FIG. 5, no vertical line can be drawn between block 10a and block 10b that does not pass through at least one of block 10a and 10b. Additionally, second end 14b of block 10b cannot be raised without also raising first end 12a of first block 10a. In such a manner, the overlapping engagement system inhibits vertical movement or slip of the blocks.

Recessed portion 22a and extension portion 42b are configured to allow close positioning of block 10a and block 10b. It is preferable that extension portion 42b is slightly smaller than recessed portion 22a, to allow extension portion 42b to easily fit within recessed portion 22a and allow sufficient volume for alignment adjustments. When connected, first end 12a is preferably in close contact with second end 14b. It is not necessary that endmost portion 20b or extension portion 42b abuts and contacts the surfaces defining recessed portion 22a, however, contact between at least a portion of recessed portion 22a at first end 12a and second end 14b is preferred. In some embodiments, in order to obtain a desired edging or border configuration, two blocks 10a, 10b may be pivoted in respect to one another. That is, first end 12a may not squarely abut second 14b, but be positioned at a slight angle to one another.

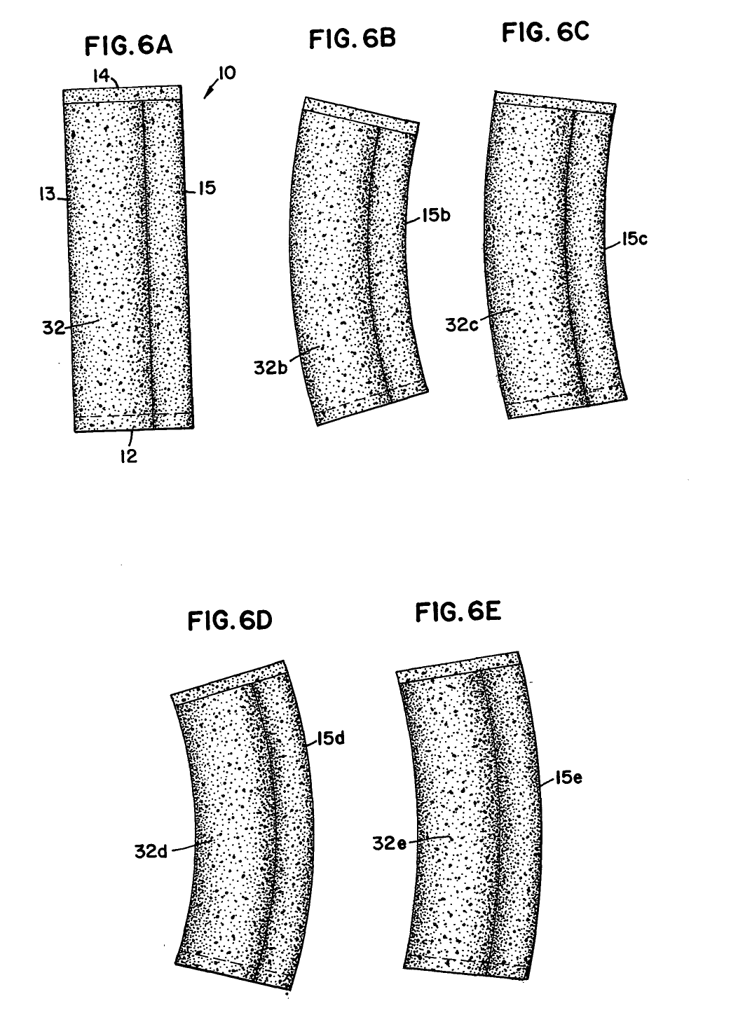

Edging block 10 may be straight or may have a curvature associated with it. Having blocks of various shapes and sizes provides versatility and allows a landscaper to customize the shape of the assembled edging to encompass the desired area. For example, a combination of blocks having different curve radiuses, and/or curving in opposite directions, allows one to make circular, scalloped or otherwise undulating borders. Various examples of blocks are illustrated in FIGS. 6A through 6E. FIG. 6A shows edging block 10, which has been described above. When installed, interior surface 15 of block 10 borders landscaping, such as trees and flowers, which would be positioned proximate to interior surface 15. Block 10 is straight; that is, block 10 has no curvature, arc or radius associated therewith. FIG. 6B shows a variation of block 10; the illustrated block has an interior surface 15b opposite mowing feature 32b. This block has a concave arc, with a first radius, in relation to interior surface 15b. FIG. 6C shows another variation of block 10, having a concave arc. This block, with interior surface 15c opposite mowing feature 32c, has a larger radius than the block of FIG. 6B. FIG. 6D shows a variant block having a convex arc, with the same radius as the block of FIG. 6B. FIG. 6E shows yet another variant block, this one with a convex arc having the larger radius of the block of FIG. 6C. In all of these, inside surface 15, 15b, 15c, 15d, 15e would be positioned proximate to the landscaping being bordered and mowing feature 32, 32b, 32c, 32d, 32e would be positioned proximate the grass. It is understood that the landscaping block could be formed having other arcs and shapes, such as a serpentine block, a right angle block, or a block having a 45-degree angle.

In each of these blocks, the engagement system is present. That is, no matter what shape or size of the landscape block, the first end would have the first, female, portion of the engagement system and the second end would have the second, male, portion of the engagement system.

An alternate design for the engagement system at the edging block's first end and second end is illustrated in FIG. 7. Referring to block 100 of FIG. 7, first end 112 has a first recessed portion 122 of the engagement system and second end 114 has a second extension portion 142 of the engagement system, which together form an overlapping engagement system. Extension portion 142 defines an endmost portion 120. Recessed portion 122 accepts at least a portion of extension portion 142, thus providing overlapping engagement between first end 112 and second end 114 of two adjacent blocks. In such a manner, the overlapping engagement system, with recessed portion 122 positioned over extension portion 142 inhibits vertical movement or slip of adjacent blocks 100.

Extension portion 142 includes a detent or key 145 extending up toward top surface 116. Recessed portion 122 has a corresponding indent or keyway 125, sized and shaped to accept detent 145. The interconnection of detent 145 with indent 125 provides lateral stability when two blocks 100 are connected and inhibits lateral movement or slip. That is, detent 145 and indent 125 inhibit movement of blocks 100 relative to each other along the block ends 112 and 114. Such a feature is beneficial for maintaining the position of blocks 100 due to inadvertent force against the blocks, for example, by large lawnmowers. Indent 125 and/or detent 145 could extend the entire length of recessed portion 122/extension portion 142, respectively, (as illustrated), or could be localized. Although one detent 145 and one corresponding indent 125 are shown, it is understood that multiple detents and/or indents could be present.

Additional edging block embodiments are shown in FIGS. 8 and 9, these embodiments having alternative cross-sectional or end profiles compared to the first embodiment. Referring to FIG. 8, an edging block 210 has an interior surface 213, an exterior surface 215, a top surface 216 and a bottom surface 218. In FIG. 8, second end 214 is shown having extension portion 242. Block 210 includes mowing feature 232 at interior surface 213. Mowing feature 232 is a continuous, sloped surface that facilitates grass mowing and trimming along block 210. Alternately, top surface 216 could function as a mowing feature. For example, during installation, block 210 could be sufficiently seated into the ground to place top surface 216 at a level to allow the wheel of a mower to ride thereon.

Referring to FIG. 9, an edging block 310 has an interior surface 313, an exterior surface 315, a top surface 316 and a bottom surface 318. In FIG. 9, second end 314 is shown having extension portion 342. Top surface 316 could function as a mowing feature for block 310. For example, during installation, block 310 could be sufficiently seated into the ground to place top surface 316 at a level to allow the wheel of a mower to ride thereon. A preferred height, from bottom surface 318 to top surface 316, if top surface 316 is to be used as a mowing feature, is about 2 inches.

Yet another embodiment of a landscape edging block is shown in FIGS. 10 and 11 as edging block 410. Block 410 has a first end 412 and an opposite second end 414. First end 412 has a convex surface, when viewed looking at first end 412 from a point external to block 410. Second end 414 has a concave surface, when viewed looking at second end 414 from a point external to block 410. In this embodiment, each of first end 412 and second end 414 are defined by a 5 inch radius. First end 412 includes recessed portion 422 and second end 414 includes extension portion 442, which overlapping engage. Block 410 may also include a stepped mowing feature, not illustrated in FIG. 10, or, block 410 could be sufficiently seated into the ground to place top surface 416 at a level to allow the wheel of a mower to ride thereon.

Blocks 10, 100, 210, 310, 410 can be designed to have an aesthetic look selected to complement the landscaping and the property. For example, the edging blocks can have a color rather than merely concrete color. Common colors include gray, sand, red, brown, and the like. The blocks may have a mottled look. The color can be present throughout the block, which is done by adding pigment to the concrete during manufacture of the block, or the color can be present on only the surface of the block.

The landscape blocks can additionally or alternatively have a decorative or ornamental surface pattern, such as a brick pattern, a field stone pattern, or the like. A natural, rough look, simulating the appearance of broken stone, could alternatively been used. Such patterns can be provided to the block during molding of the block, or can be subsequently applied.

Methods of Making Landscaping Blocks

The landscape blocks of the present invention, such as blocks 10, 100, can be made by conventional concrete block forming techniques. Although the term “concrete” is used herein, it is understood that any cementitious material can be used to form the landscape blocks. One method for making blocks 10, 100 is by a “poured in place” method, where concrete is poured into a mold. A preferred technique is one commonly referred to as dry casting or Dri-Cast. Using this method, the cast concrete block is removed from the mold prior to curing. When using a casting or dry casting method, typical concrete ingredients, water, cement, sand, and aggregate, are mixed. Pigment may be optionally added. A wide variety of mixtures are known to make blocks having various characteristics such as strength, water absorption, density, shrinkage, and other factors meeting ASTM standards and depending on the desired application of the block. When using dry casting techniques, the amount of water in the mixture is significantly less than that used for common concrete casting or wet casting. After mixing, the mixture is placed in a hopper that transports the mixture to a block molding machine. Any block molding machine known in the art may be used. Suitable molding machines for dry casting procedures are available, for example, from Besser Company of Alpena, Mich. The mixture or fill is then poured or loaded into a mold sitting on a large plate. The mold is configured to provide the desired block as a single unit. Often, multiple blocks are obtained from one mold. After filling, the top of the mold is scraped with a cut-off bar to remove excess concrete mixture. The mold and concrete is then subjected to vertical compression to compress the concrete within the mold for a period of time sufficient to form a solid, contiguous block. Generally, each block producing cycle has a duration of six to twelve seconds at a total load of 1500 to 2000 pounds. Additionally, the mold and/or the plate may be agitated during compression. Once the compression is complete, the plate is lowered vertically away from the mold into a de-molding or stripped position and the newly molded block is pushed downward through the mold so that it remains on the plate.

Once the block is formed, it is cured by various means known in the art. Typically, blocks are cured in kilns for up to twenty-four hours under pressure and/or under high temperature, typically with steam. Once cured, multiple connected blocks may be split by known methods. After splitting, individual blocks are palletized or otherwise packaged for shipment or storage.

Methods of Installing Landscape Blocks

The landscape blocks of the present invention, such as blocks 10, 100, can be installed by a professional landscaper or by a homeowner, using minimal equipment. Prior to installation, the design for the desired edging border should be planned. Using a combination of straight and arced blocks, either or both convex and concave blocks, provides a natural, flowing edging that adapts to the landscape and is aesthetically pleasing.

Once obtained, the blocks can merely be placed on the ground surface. In some embodiments, it may be desirable to remove any grass or other vegetation that would be present under the edging blocks. A trench or ditch may be dug to seat the blocks lower. It may be desirable to include a base of gravel, rock or sand under the blocks for stability. Once a first block is placed on the ground, the first end of the first block, such as first end 12a of block 10a of FIG. 4, is placed against the second end of a second block, such as second end 14b of second block 10b in FIG. 4. In such a continuing manner, the individual blocks are arranged to create the desired edging. It is not necessary that the first end of a first block tightly abut the second end of a second block. Because of the overlapping engagement system of the blocks, a slight spacing can be maintained between adjacent blocks without allowing grass or other vegetation to grow therebetween. Similarly, it is not necessary that the first end of the first block be square with the second end of the second block, rather, the blocks may be angled with respect to one another.

Because of the individual blocks forming the edging border, the layout of the landscape edging can be changed, as desired. For example, the shape of the edging border can be modified, or additional blocks can be added or removed to change the shape and enclosed size of the border.

Exemplary Embodiments

Referring to FIGS. 2, 3 and 4, dimensions for one preferred embodiment are described herein. Edging block 10, has an end view taken along first end 12,

Edging block 10 has a length from first end 12 to second end 14 of approximately 16 inches, with the length of block, from first end 12 to endmost portion 20 at second end 14 being approximately 16⅝ inches. Block 10 has a height from top surface 16 to bottom surface 18 of approximately 4 inches, and a width from front side 13 to back side 15 of about 2 inches at top surface 16 and about 6 inches at bottom surface 18. The displacement or distance from top surface 16 to shelf 34 is approximately 2 inches, and the distance from bottom surface 18 to shelf 34 is approximately 2 inches. The transition from shelf 34 to bottom portion 36 is defined by a 1 inch radius. Similarly, the transition from shelf 34 to first portion 30 is defined by a 1 inch radius. Each of the transitions between top surface 16 and exterior side 13 and top surface 16 and interior side 15 is defined by a 3/8 inch radius. Recessed portion 22 extends in from first end 12 approximately 3/4 inch and extends up from bottom surface 18 approximately 5/8 inch at its deepest point and approximately 7/8 at first end 12. Extension portion 42 extends out from second end 14 approximately 5/8 inch to define endmost portion 20. The height of extension portion 42 at second end 14 is approximately 3/4 inch, and at endmost portion 20 is approximately ½.

Referring to FIGS. 6B and 6D, those blocks having a first radius, the maximum length, measured from the outermost portion to the opposite end, along the longer side, is approximately 17¼ inch. The length, measured from the outermost portion to the opposite end, along the shorter side, is approximately 13½ inch. The shorter side (e.g., interior surface 15b of FIG. 6B) is defined by a 24 inch radius. The longer side (e.g., interior surface 15d of FIG. 6D) is defined by a 30 inch radius. The width of the blocks is approximately 6 inches.

Referring to FIGS. 6C and 6E, those blocks having a second, smaller radius, the maximum length, measured from the outermost portion to the opposite end, along the longer side, is approximately 17¼ inch. The length, measured from the outermost portion to the opposite end, along the shorter side, is approximately 15½ inch. The shorter side (e.g., interior surface 15c of FIG. 6C) is defined by a 54 inch radius. The longer side (e.g., interior surface 15e of FIG. 6E) is defined by a 60 inch radius. The width of the blocks is approximately 6 inches.

The above specification, examples and data provide a complete description of the manufacture and use of the composition of the invention. Since many embodiments of the invention can be made without departing from the spirit and scope of the invention, the invention resides in the claims hereinafter appended.

1. A concrete landscape edging block comprising:
(a) a body having a first end, an opposite second end, a front surface, an opposite back surface, a bottom surface and a top surface;
(b) a first, recessed engagement portion at the first end;
(c) a second, extension engagement portion at the second end and extending away from the second end, the second extension engagement portion corresponding to and interconnectable with the first recessed engagement portion; and
(d) a mowing feature present in the front surface, the mowing feature comprising a generally flat ledge positioned along one of the front and back surfaces between the top and bottom surfaces and having an orientation to lie substantially horizontal when the bottom surface rests on the ground, the ledge dividing the body into an upper decorative edging portion and a lower portion to be substantially buried in the ground.

2. The edging block according to claim 1, wherein the second extension engagement portion includes a detent and the first recessed engagement portion includes an indent corresponding to the detent.

3. The edging block according to claim 1, wherein the mowing feature includes a ledge displaced from the top surface and extending approximately parallel to the bottom surface.

4. The edging block according to claim 1, having a length from the first end to the second end of about 12 to 24 inches.

5. The edging block according to claim 1, wherein the block is straight.

6. The edging block according to claim 1, wherein the block is convex in relation to the back surface.

7. The edging block according to claim 6, wherein the block is convex having a first radius.

8. The edging block according to claim 1, wherein the block is concave in relation to the back surface.

9. The edging block according to claim 8, wherein the block is concave having a first radius.

10. The edging block according to claim 1, wherein each of the first end is concave and the second end is convex.

11-17. (cancelled)

18. A plurality of edging blocks connected to form an edging border and as partially buried in the ground, the edging border comprising:
(a) a first block having
(i) a body having a first end, an opposite second end, a front surface, an opposite back surface, a bottom surface and a top surface;
(ii) a first engagement portion at the first end;
(iii) a second engagement portion at the second end, the second engagement portion corresponding to and interconnectable with the first engagement portion; and
(iv) a mowing feature comprising a generally flat ledge positioned along one of the front and back surfaces between the top and bottom surfaces and having an orientation to lie substantially horizontal when the bottom surface rests on the ground, the ledge dividing the body into an upper decorative edging portion and a lower portion that is substantially buried in the ground; and
(b) a second block having
(i) a body having a first end, an opposite second end, a front surface, an opposite back surface, a bottom surface and a top surface;
(ii) a first engagement portion at the first end;
(iii) a second engagement portion at the second end, the second engagement portion corresponding to and interconnectable with the first engagement portion; and
(iv) a mowing feature comprising a generally flat ledge positioned along one of the front and back surfaces between the top and bottom surfaces and having an orientation to lie substantially horizontal when the bottom surface rests on the ground, the ledge dividing the body into an upper decorative edging portion and a lower portion that is substantially buried in the ground;
wherein the first engagement portion of the first block is engaged at least partially with the second engagement portion of the second block.

19. The edging border according to claim 18, wherein the first end of the first block abuts the second end of the second block.

20. The edging border according to claim 18, wherein the first end of the first block is angled in relation to the second end of the second block.

21. The edging border according to claim 18, wherein the first block is straight and the second block is one of a convex block or a concave block.

22. The edging border according to claim 18, further comprising:
(a) a third block having
(i) a body having a first end, an opposite second end, a front surface, an opposite back surface, a bottom surface and a top surface;
(ii) a first engagement portion at the first end;
(iii) a second engagement portion at the second end, the second engagement portion corresponding to and interconnectable with the first engagement portion;
(b) a fourth block having
(i) a body having a first end, an opposite second end, a front surface, an opposite back surface, a bottom surface and a top surface;
(ii) a first engagement portion at the first end;
(iii) a second engagement portion at the second end, the second engagement portion corresponding to and interconnectable with the first engagement portion;
the first engagement portion of the first block engaged at least partially with the second engagement portion of the second block, the first engagement portion of the second block engaged at least partially with the second engagement portion of the third block, and the first engagement portion of the third block engaged at least partially with the second engagement portion of the fourth block, wherein the third block.

23. The edging border according to claim 18, each of the first block and the second block comprising a mowing feature on the front surface.

24-26. (cancelled)

27. A landscape edging block, the landscape edging block comprising,
a body having a ground engaging surface, a top surface spaced from the ground engaging surface, and first and second ends;
a first mating feature of partial thickness of the body extending from the first end of the body, the first mating feature comprising at least a portion of the top surface of the body and comprising a concave end surface;
a second mating feature of partial thickness of the body extending from the second end of the body, the second mating feature comprising at least a portion of the ground engaging surface of the body and comprising a convex end surface, the second mating feature for mating with a mating feature of another similar landscape edging block;
wherein the first and second mating features provide overlapping engagement and angular adjustability as between a plurality of landscape edging blocks arranged to form a landscape edging border.
